(19) United States
(12) Patent Application Publication
(10) Pub. No.: US 2011/0096548 A1
(43) Pub. Date: Apr. 28, 2011

(54) HYBRID REFLECTOR SYSTEM FOR LIGHTING DEVICE

(76) Inventor: PAUL KENNETH PICKARD, Morrisville, NC (US)

(21) Appl. No.: 12/606,377

(22) Filed: Oct. 27, 2009

(51) Int. Cl. F21V 29/00; F21V 7/00; F21V 5/00; F21V 7/20; F21V 7/07

(52) U.S. Cl. 362/294; 362/347; 362/327; 362/345; 362/296.01; 362/296.05

(57) ABSTRACT

A hybrid reflector system for use in lighting application. The system is particularly well-suited for use with solid state light sources, such as light emitting diodes (LEDs). Embodiments of the system include a bowl-shaped outer reflector and an intermediate reflector disposed inside the bowl and proximate to the light source. The reflectors are arranged to interact with the light emitted from the source to produce a beam having desired characteristics. Some of the light passes through the system without interacting with any of the reflector surfaces. This uncontrolled light, which is already emitting in a useful direction, does not experience optical loss normally associated with one or more reflective bounces. Some of the light emanating from the source at higher angles that would not be emitted within the desired beam angle is reflected by one or both of the reflectors, redirecting that light to achieve a tighter beam.

### BACKGROUND OF THE INVENTION

1. Field of the Invention

The invention relates generally to reflector systems for lighting applications and, more particularly, to reflector systems for solid state light sources.

2. Description of the Related Art

Light emitting diodes (LEDs) are solid state devices that convert electric energy to light and generally comprise one or more active regions of semiconductor material interposed between oppositely doped semiconductor layers. When a bias is applied across the doped layers, holes and electrons are injected into the active region where they recombine to generate light. Light is produced in the active region and emitted from surfaces of the LED.

In order to generate a desired output color, it is sometimes necessary to mix colors of light which are more easily produced using common semiconductor systems. Of particular interest is the generation of white light for use in everyday lighting applications. Conventional LEDs cannot generate white light from their active layers; it must be produced from a combination of other colors. For example, blue emitting LEDs have been used to generate white light by surrounding the blue LED with a yellow phosphor, polymer or dye, with a typical phosphor being cerium-doped yttrium aluminum garnet (Ce:YAG). The surrounding phosphor material “downconverts” some of the blue light, changing it to yellow light. Some of the blue light passes through the phosphor without being changed while a substantial portion of the light is downconverted to yellow. The LED emits both blue and yellow light, which combine to yield white light.

In another known approach, light from a violet or ultraviolet emitting LED has been converted to white light by surrounding the LED with multicolor phosphors or dyes. Indeed, many other color combinations have been used to generate white light.

Because of the physical arrangement of the various source elements, multicolor sources often cast shadows with color separation and provide an output with poor color uniformity. For example, a source featuring blue and yellow sources may appear to have a blue tint when viewed head on and a yellow tint when viewed from the side. Thus, one challenge associated with multicolor light sources is good spatial color mixing over the entire range of viewing angles. One known approach to the problem of color mixing is to use a diffuser to scatter light from the various sources.

Another known method to improve color mixing is to reflect or bounce the light off of several surfaces before it is emitted. This has the effect of disassociating the emitted light from its initial emission angle. Uniformity typically improves with an increasing number of bounces, but each bounce has an associated optical loss. Some applications use intermediate diffusion mechanisms (e.g., formed diffusers and textured lenses) to mix the various colors of light. Many of these devices are lossy and, thus, improve the color uniformity at the expense of the optical efficiency of the device.

Typical direct view lamps, which are known in the art, emit both uncontrolled and controlled light. Uncontrolled light is light that is directly emitted from the lamp without any reflective bounces to guide it. According to probability, a portion of the uncontrolled light is emitted in a direction that is useful for a given application. Controlled light is directed in a certain direction with reflective or refractive surfaces. The mixture of uncontrolled and controlled light define the output beam profile.

Also known in the art, a retroreflective lamp arrangement, such as a vehicle headlamp, utilizes multiple reflective surfaces to control all of the emitted light. That is, light from the source either bounces off an outer reflector (single bounce) or it bounces off a retroreflector and then off of an outer reflector (double bounce). Either way the light is redirected before emission and, thus, controlled. In a typical headlamp application, the source is an omni-emitter, suspended at the focal point of an outer reflector. A retroreflector is used to reflect the light from the front hemisphere of the source back through the envelope of the source, changing the source to a single hemisphere emitter.

Many modern lighting applications demand high power LEDs for increased brightness. High power LEDs can draw large currents, generating significant amounts of heat that must be managed. Many systems utilize heat sinks which must be in good thermal contact with the heat-generating light sources. Some applications rely on cooling techniques such as heat pipes which can be complicated and expensive.

### SUMMARY OF THE INVENTION

A reflector system according to an embodiment of the present invention comprises the following elements. An outer reflector has a bowl shape with a base end and an open end. An intermediate reflector is disposed inside the outer reflector. The intermediate reflector is shaped to define an axial hole.

A lamp device according to an embodiment of the present invention comprises the following elements. A light source is mounted at a base end of an outer reflector. The light source is arranged to emit light toward an open end of the outer reflector. An intermediate reflector is disposed proximate to the light source, the intermediate reflector shaped to define a hole for at least some light from the light source to pass through. A housing is arranged to surround the outer reflector without obstructing the open end. A lens is arranged to cover the open end.

A lamp device according to an embodiment of the present invention comprises the following elements. An outer reflector comprises a plurality of panels, each of the panels having a cross-section defined by a compound parabola. The panels are arranged around a longitudinal axis to define a cavity and an open end. An intermediate reflector is disposed in the cavity and along the longitudinal axis.

### BRIEF DESCRIPTION OF THE DRAWINGS

FIG. 1 is a perspective view of a lamp device according to an embodiment of the present invention.

FIG. 2 is a bottom view of a lamp device according to an embodiment of the present invention.

FIG. 3 is a side cut-away view of a lamp device according to an embodiment of the present invention.

FIG. 4 is a side view of a lamp device according to an embodiment of the present invention.

FIG. 5 is an exploded view of a lamp device according to an embodiment of the present invention.

FIG. 6 is a cross-sectional view of a lamp device with an overlay of light emission regions within the device according to an embodiment of the present invention.

FIG. 7 is a cross-sectional view of a lamp device with an overlay of light emission regions within the device according to an embodiment of the present invention.

FIG. 8 is a perspective view of a lamp device according to an embodiment of the present invention.

FIG. 9 is an exploded view of a lamp device according to an embodiment of the present invention.

FIG. 10 is a bottom view of a lamp device according to an embodiment of the present invention.

FIG. 11 is an exploded view of a lamp device according to an embodiment of the present invention.

FIG. 12 is a side view of a lamp device according to an embodiment of the present invention.

FIG. 13 is a magnified side view of a corner portion of a lamp device according to an embodiment of the present invention.

FIG. 14 shows a perspective view of an intermediate reflector according to an embodiment of the present invention.

FIG. 15 shows a perspective view of an intermediate reflector according to an embodiment of the present invention.

FIG. 16 is a cross-sectional view of an intermediate reflector according to an embodiment of the present invention.

FIGS. 17a and 17b are cross-sectional views of an intermediate reflector according to an embodiment of the present invention.

### DETAILED DESCRIPTION OF THE INVENTION

Embodiments of the present invention provide an improved hybrid reflector system for use in lighting applications. The hybrid reflector system is particularly well-suited for use with solid state light sources, such as light emitting diodes (LEDs). Embodiments of the system include a bowl-shaped outer reflector and an intermediate reflector disposed inside the bowl and proximate to the light source. The reflectors are arranged to interact with the light emitted from the source to produce a beam having desired characteristics. The reflector arrangement allows some of the light to pass through the system without interacting with any of the reflector surfaces. This uncontrolled light, which is already emitting in a useful direction, does not experience the optical loss that is normally associated with one or more reflective bounces. Some of the light emanating from the source at higher angles that would not be emitted within the desired beam angle is reflected by one or both of the reflectors, redirecting that light to achieve a tighter beam.

It is understood that when an element is referred to as being “on” another element, it can be directly on the other element or intervening elements may also be present. Furthermore, relative terms such as “inner,” “outer,” “upper,” “bottom,” “above,” “lower,” “beneath,” and “below,” and similar terms, may be used herein to describe a relationship of one element to another. It is understood that these terms are intended to encompass different orientations of the device in addition to the orientation depicted in the figures.

Although the ordinal terms first, second, etc., may be used herein to describe various elements, components, regions and/or sections, these elements, components, regions, and/or sections should not be limited by these terms. These terms are only used to distinguish one element, component, region, or section from another. Thus, unless expressly stated otherwise, a first element, component, region, or section discussed below could be termed a second element, component, region, or section without departing from the teachings of the present invention.

As used herein, the term “source” can be used to indicate a single light emitter or more than one light emitter. For example, the term may be used to describe a single blue LED, or it may be used to describe a red LED and a green LED in proximity. Thus, the term “source” should not be construed as a limitation indicating either a single-element or a multi-element configuration unless clearly stated otherwise.

The term “color” as used herein with reference to light is meant to describe light having a characteristic average wavelength; it is not meant to limit the light to a single wavelength. Thus, light of a particular color (e.g., green, red, blue, yellow, etc.) includes a range of wavelengths that are grouped around a particular average wavelength.

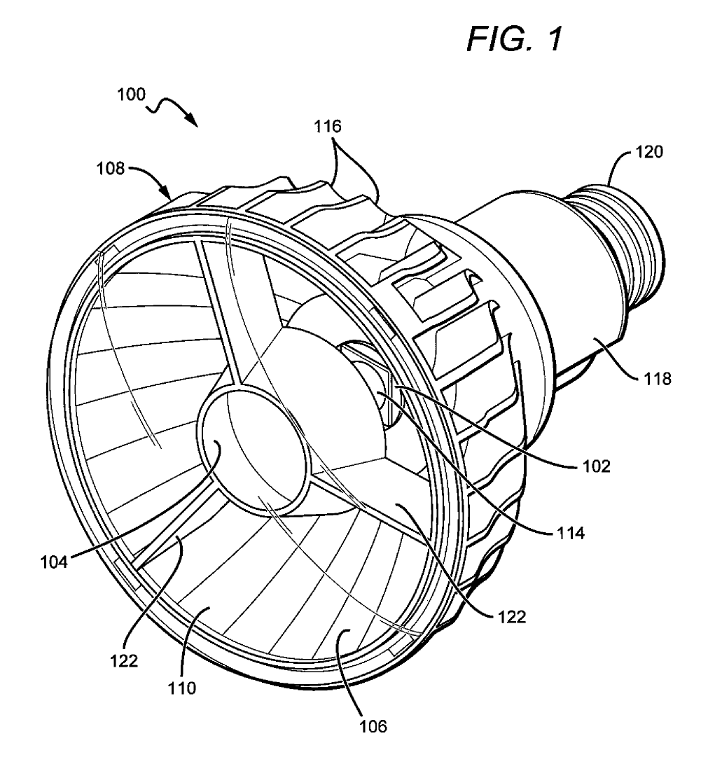

FIGS. 1-5 show various views of a lamp device 100 according to an embodiment of the present invention.

FIG. 1 is a perspective view of the lamp device 100. A light source 102 is disposed at the base of a bowl-shaped region within the lamp 100. Many applications, for example white light applications, necessitate a multicolor source to generate a blend of light that appears as a certain color to the human eye. In some embodiments multiple LEDs or LED chips of different colors or wavelength are employed, each in a different location with respect to the optical system. Because these wavelengths are generated in different locations and therefore follow different paths through the optical system, it is necessary to mix the light sufficiently so that color patterns are not noticeable in the output, giving the appearance of a homogenous source. Furthermore, even in embodiments wherein homogenous wavelength emitters are employed, it is advantageous to mix light from different locations in order to avoid projecting an image of the optical source onto the target.

An intermediate reflector 104 is disposed proximate to the light source 102. Some of the light emitted from the source 102 interacts with the intermediate reflector 104 such that it is redirected toward an outer reflector 106. The outer reflector 106 and the intermediate reflector 104 work in concert to shape the light into a beam having characteristics that are desirable for a given application. A protective housing 108 surrounds the light source 102 and the reflectors 104, 106. The source 102 is in good thermal contact with the housing 108 at the base of the outer reflector 106 to provide a pathway for heat to escape into the ambient. A lens 110 covers the open end of the housing 108 and provides protection from outside elements.

The light source 102 may comprise one or more emitters producing the same color of light or different colors of light. In one embodiment, a multicolor source is used to produce white light. Several colored light combinations will yield white light. For example, it is known in the art to combine light from a blue LED with wavelength-converted yellow light to create a white output. Both blue and yellow light can be generated with a blue emitter by surrounding the emitter with phosphors that are optically responsive to the blue light. When excited, the phosphors emit yellow light which then combines with the blue light to make white. In this scheme, because the blue light is emitted in a narrow spectral range it is called saturated light. The yellow light is emitted in a much broader spectral range and, thus, is called unsaturated light. Another example of generating white light with a multicolor source is combining the light from green and red LEDs. RGB schemes may also be used to generate various colors of light. In some applications, an amber emitter is added for an RGBA combination. The previous combinations are exemplary; it is understood that many different color combinations may be used in embodiments of the present invention. Several of these possible color combinations are discussed in detail in U.S. Pat. No. 7,213,940 to Van de Ven et al. which is commonly assigned with the present application to CREE LED LIGHTING SOLUTIONS, INC. and fully incorporated by reference herein.

Color combinations can be achieved with a singular device having multiple chips or with multiple discreet devices arranged in proximity to each other. For example, the source 102 may comprise a multicolor monolithic structure (chip-on-board) bonded to a printed circuit board (PCB).

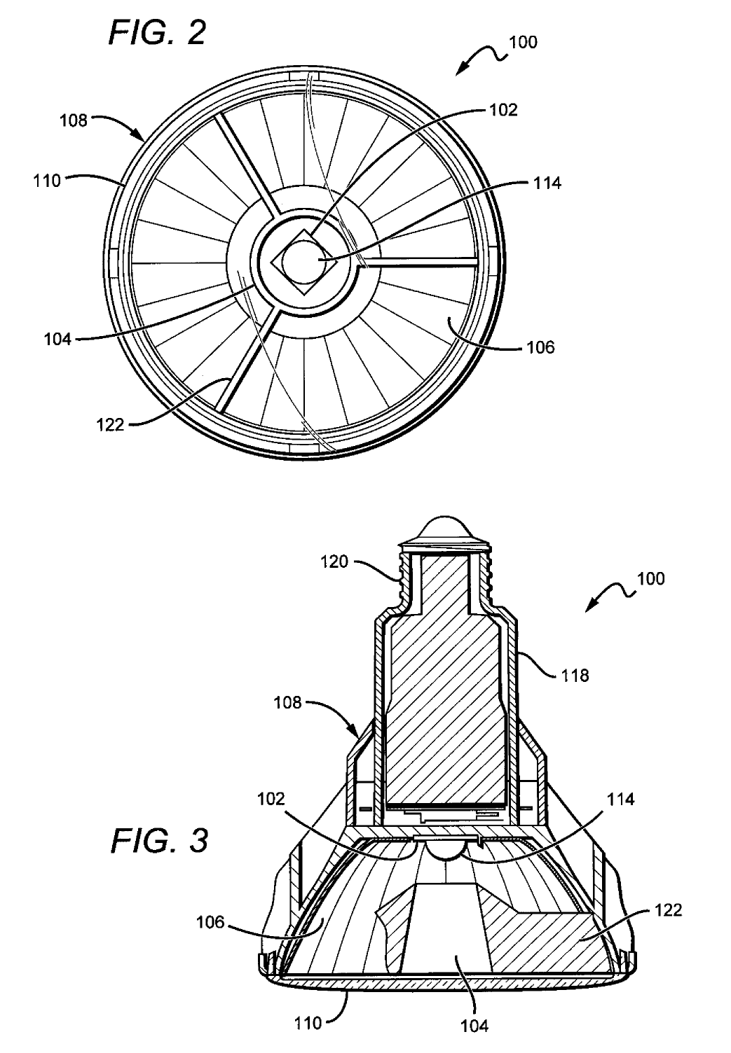

FIG. 2 shows a bottom view of the lamp device 100, looking through the intermediate reflector 104 at the source 102. In some embodiments, several LEDs are mounted to a submount to create a single compact optical source. Examples of such structures can be found in U.S. patent application Ser. Nos. 12/154,691 and 12/156,995, both of which are assigned to CREE, INC., and both of which are fully incorporated by reference herein. In the embodiment shown in FIG. 1, the source 102 is protected by an encapsulant 114. Encapsulants are known in the art and, therefore, only briefly discussed herein. The encapsulant 114 material may contain wavelength conversion materials, such as phosphors for example.

The encapsulant 114 may also contain light scattering particles, voids or other optically active structures to help with the color mixing process in the near field. Although light scattering particles, voids or other optically active structures dispersed within or on the encapsulant 114 may cause optical losses, it may be desirable in some applications to use them in concert with the reflectors 104, 106 so long as the optical efficiency is acceptable.

In those embodiments in which the light source 102 is one or more LEDs, there may be more than one point of emission that needs to be considered. It is, therefore, beneficial to integrate a diffusive element into the lamp device.

Color mixing in the near field may be aided by providing a scattering/diffuser material or structure in close proximity to the light sources. A near field diffuser is in, on, or in close proximity to the light sources with the diffuser arranged so that the source can have a low profile while still mixing the light in the near field. By diffusing in the near field, the light may be pre-mixed to a degree prior to interacting with either of the reflectors 104, 106. Techniques and structures for near field mixing are discussed in detail in U.S. patent application Ser. No. 12/475,261 by Negley, et al. and assigned to CREE, INC. This application is incorporated by reference as if fully set forth herein.

A diffuser can comprise many different materials arranged in many different ways. In some embodiments, a diffuser film can be provided on the encapsulant 114. In other embodiments, the diffuser can be included within the encapsulant 114. In still other embodiments, the diffuser can be remote from the encapsulant, such as on the lens 110 as discussed in detail hereafter. The lens 110 may be textured across an entire surface, or it may have a certain portion that is textured such as an annular region, for example, depending on the application. Various diffusers can be used in combination. For example, both the encapsulant 114 and the lens 110 may comprise diffusive elements.

In embodiments comprising a diffuser film disposed on the lens 110, it is possible to adjust the profile of the output beam by adjusting the properties of the diffuser film. One property that may be adjusted is the output beam angle which can be narrowed or widened by using a weaker or stronger diffuser film, respectively.

For example, a lamp device designed to produce an output beam having a 50 degree beam angle can be adjusted to provide a beam having a 60 degree beam angle simply by including a stronger diffuser film on the lens. Thus, in some embodiments the output beam can be tailored by tweaking or replacing an inexpensive and easily accessible diffuser film without having to change the arrangement or structure of the intermediate and outer reflectors 104, 106.

Many different structures and materials can be used as a diffuser such as scattering particles, geometric scattering structures or microstructures, diffuser films comprising microstructures, or diffuser films comprising index photonic films. The diffuser can take many different shapes; it can be flat, hemispheric, conic, or variations of those shapes, for example.

The encapsulant 114 may also function as a lens to shape the beam prior to incidence on the reflectors 104, 106. The encapsulant may be hemispherical, parabolic, or another shape, depending on the particular optical effect that is desired.

FIG. 3 is a side cut-away view of the lamp device 100, showing the internal environment of the device 100. The housing 108 surrounds the outer reflector 106, protecting the internal components of the lamp device 100. The external portion of the housing 108 is best shown in FIG. 4, which is a side view of the lamp device 100. The lens 110 and the housing 108 may form a watertight seal to keep moisture from entering into the internal areas of the device 100. In some embodiments, an edge of the lens 110 remains exposed beyond the open end of the outer reflector 106 as discussed in further detail with reference to FIG. 13. In other embodiments, the lens may be recessed in the housing and connected to an inside surface thereof.

A portion of the housing 108 may comprise a material that is a good thermal conductor, such as aluminum or copper. The thermally conductive portion of the housing 108 can function as a heat sink by providing a path for heat from the source 102 through the housing 108 into the ambient. The source 102 is disposed at the base of the secondary reflector 106 such that the housing 108 can form good thermal contact with the source 102. To facilitate the transfer of heat, the housing 108 may include fin-shaped structures 116 which increase the surface area of the housing 108. Thus, the source 102 may comprise high power LEDs that generate large amounts of heat.

Power is delivered to the source 102 through a protective conduit 118. The lamp device 100 may be powered by a remote source connected with wires running through the conduit 118, or it may be powered internally with a battery that is housed within the conduit 118. The conduit 118 may have a threaded end 120 for mounting to an external structure. In one embodiment, an Edison screw shell may be attached to the threaded end 120 to enable the lamp 100 to be used in a standard Edison socket. Other embodiments can include custom connectors such as a GU24 style connector, for example, to bring AC power into the lamp 100. The device 100 may also be mounted to an external structure in other ways. The conduit 118 functions not only as a structural element, but may also provide electrical isolation for the high voltage circuitry that it houses which helps to prevent shock during installation, adjustment and replacement. The conduit 118 may comprise an insulative and flame retardant thermoplastic or ceramic, although other materials may be used.

In this particular embodiment, the intermediate reflector 104 is suspended between the source 102 and the open end of the outer reflector 106 by three supportive legs 122 extending from the intermediate reflector 104 through the outer reflector 106 to the housing. In other embodiments, more or fewer legs can be used to support the intermediate reflector 104. The outer reflector 106 may comprise slits 123 to allow the legs 122 of the intermediate reflector 104 to connect with the housing 108. In other embodiments, the intermediate reflector 104 may snap-fit directly into the lens 110, eliminating the need for structures connected to the outer reflector 106 altogether.

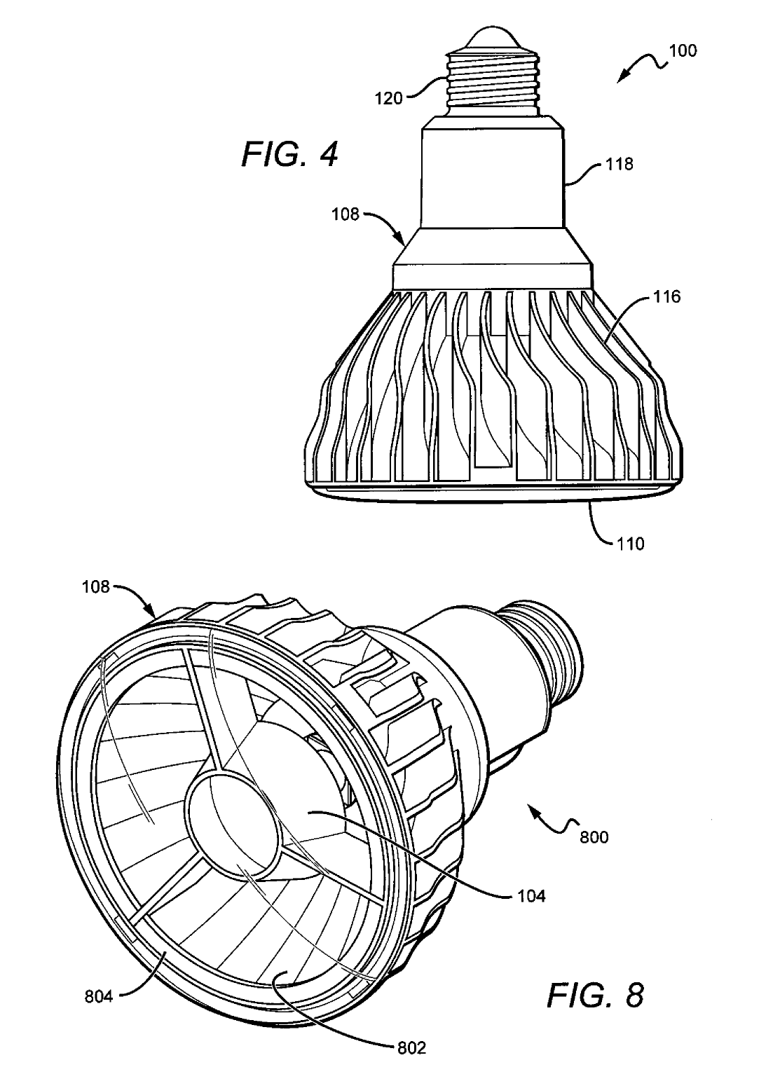

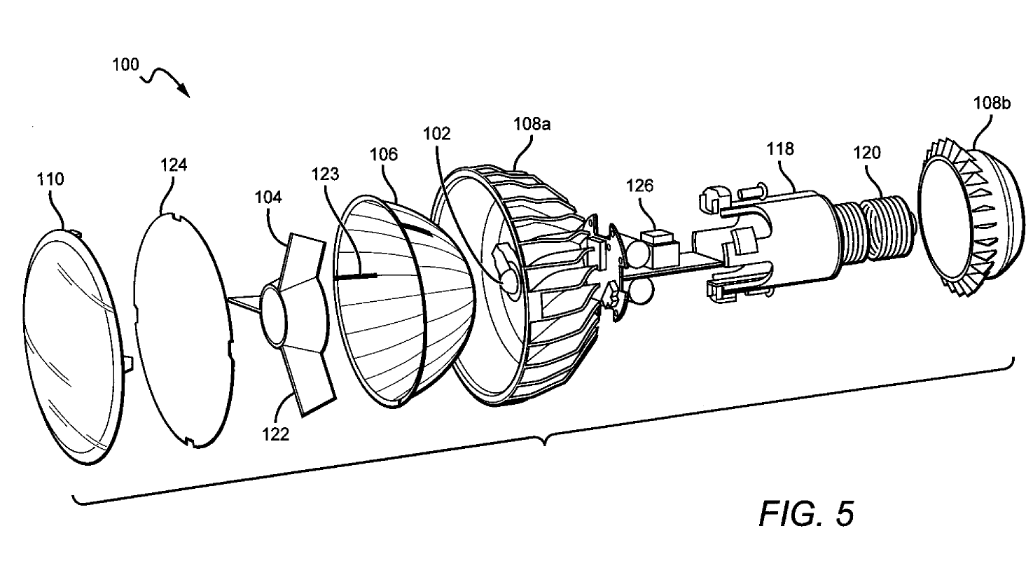

FIG. 5 is an exploded view of the lamp device 100. In this embodiment, a diffuser film 124 is disposed on the internal side of the lens 110 as shown. The diffuser film 124 may be uniformly diffusive across its entire face, or it may be patterned to have a non-uniform diffusive effect. For example, in some embodiments, the diffuser may be more diffusive in an annular region around the perimeter of the film 124 to provide additional scattering of the light which is incident on the outer perimeter portion of the lens 110.

As mentioned herein, the source 102 may be powered with an external source or an internal source. Internal power components 126 are protected by the housing 108 as shown. The power components 126 may comprise voltage and current regulation circuitry and/or other electronic components. Batteries may also be disposed within the housing for those embodiments having an internal power source or to act as a backup in case an external power source fails. The housing 108 may comprise a single piece, or it can comprise multiple components 108a, 108b as shown in FIG. 5. Multiple components 108a, 108b can be separable for easy access to the internal power components 126.

The characteristics of the output light beam are primarily determined by the shape and arrangement of the intermediate reflector 104, the outer reflector 106, and the diffuser film 124, if present.

The outer reflector 106 has a bowl or dome shape. The reflective surface of the outer reflector 106 may be smooth or faceted (as shown FIG. 5). The lamp device 100 comprises a faceted outer reflector 106 with 24 adjacent panels. The faceted surface helps to further break up the image of the different colors from the source 102. This is one suitable construction for the 25 degree beam angle output of the device 100. Other constructions are possible. The outer reflector 106 may be specular or diffuse. Many acceptable materials may be used to construct the outer reflector 106. For example, a polymeric material which has been flashed with a metal may used. The outer reflector 106 can also be made from a metal, such as aluminum or silver.

The outer reflector 106 principally functions as a beam shaping device. Thus, the desired beam shape will influence the shape of the outer reflector 106. The outer reflector 106 is disposed such that it may be easily removed and replaced with other secondary reflectors to produce an output beam having particular characteristics. In the device 100, the outer reflector 106 has a compound parabolic cross section with a truncated end portion that allows for a flat surface on which to mount the source 102.

The compound parabolic shape of outer reflector 106 focuses light from the source 102 at two different points. Each parabolic section of the outer reflector has a different focus. For example, in lamp device 100, one of the parabolic sections of the reflector 106 provides a focus that is 5 degrees off axis, while the other parabolic section provides a focus that is 10 degrees off axis. Many different output profiles can be achieved by tweaking the shape of the outer reflector 106 or the sections that compose outer reflector 106.

The outer reflector 106 may be held inside the housing 108 using known mounting techniques, such as screws, flanges, or adhesives. In the embodiment of FIG. 5, the outer reflector 106 is held in place by the lens plate 110 which is affixed to the open end of the housing 108. The lens plate 110 may be removed, allowing easy access to the outer reflector 106 should it need to be removed for cleaning or replacement, for example. The lens plate 110 may be designed to further tailor the output beam. For example, a convex shape may be used to tighten the output beam angle. The lens plate 110 may have many different shapes to achieve a desired optical effect.

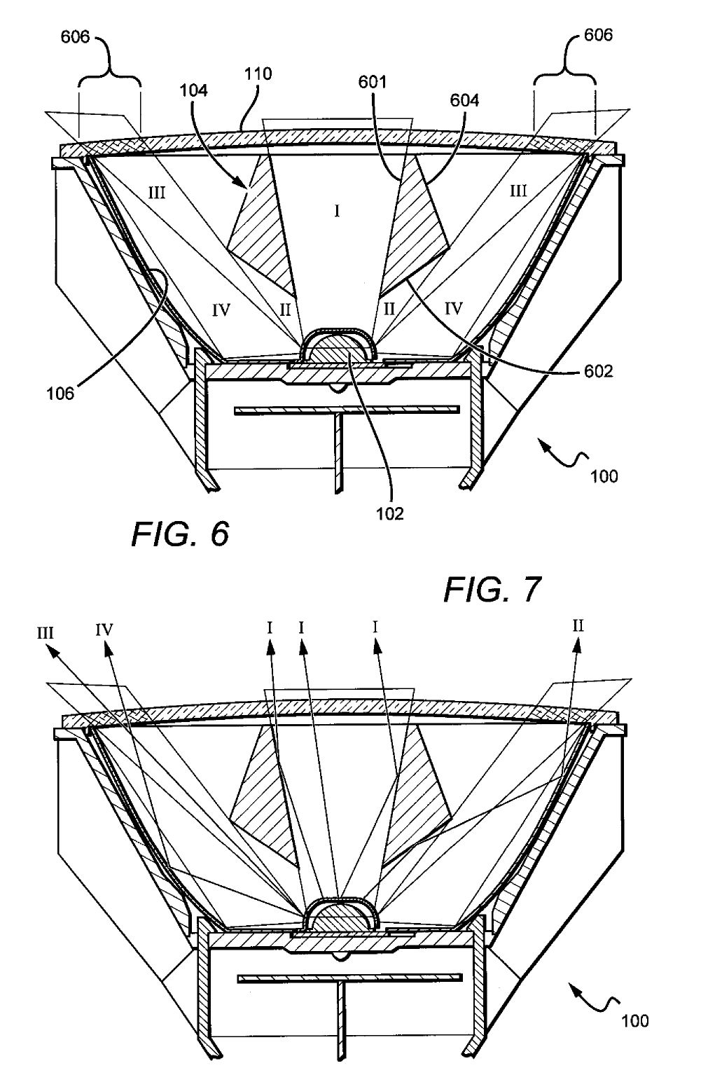

At least some of the light emitted from the source 102 interacts with the intermediate reflector 104. FIGS. 6 and 7 are cross-sectional views of lamp device 100 showing how light emitted within different ranges of angles interacts with the reflectors 104, 106. In this embodiment, the intermediate reflector 104 is shaped to define a frusto-conical hole aligned along a longitudinal axis running from the center of the base end to the center of said open end of said outer reflector 106. Although the internal surface 601 of the intermediate reflector 104 is linear in this embodiment, it is understood that the surface may be curved or curvilinear and may be segmented. The light emitted from source 102 is emitted into one of four regions as shown in FIGS. 6 and 7.

FIG. 6 illustrates four regions I, II, III and IV into which the light is initially emitted.

Light emitted in region I from the front of the source 102 passes freely through the axial hole in the intermediate reflector 104 out toward the open end of the outer reflector 106. Some of the light reflects off the reflective internal surface 601 of the intermediate reflector 104 before it escapes.

Because the intermediate reflector 104 is spaced from the light source 102, some of the light is initially emitted into region II. This light is incident on a first exterior surface 602 of the intermediate reflector 104 that faces the base end of the outer reflector 106 at an angle. The exterior surface 602 comprises a reflective material such that light that is incident on the surface 602 is reflected toward outer reflector 106 and ultimately redirected out of the device 100. Without the exterior surface 602, the region II light would escape the device 100 at an angle that is too large for the light to be within the target beam width. Thus, the exterior surface 602 and the outer reflector 106 provide a double-bounce path that allows the region II light to remain largely within the same angular distribution as the light emitted in region I.

Light that is emitted in region III passes to the lens 110 without impinging on either of the reflectors 104, 106.

Another portion of the light is initially emitted in region IV. This light is incident on the outer reflector 106 and redirected out of the device 100, most of which is emitted within the desired angular distribution of the region I light. A second exterior surface 604 of the intermediate reflector 104 faces the open end of the outer reflector 106 at an angle such that substantially all of the region IV light that reflects off the outer reflector 106 is not obscured by the intermediate reflector 104. Thus, it only incurs one reflective bounce.

The only light that is emitted outside the desired angular distribution is the light initially emitted in region III. To compensate, the lens 110 may comprise a textured region 606 around the outer perimeter. In some embodiments a diffusive film may be included on or adjacent to the lens 110 instead of or in combination with a textured lens as discussed herein. Diffusion near the perimeter of the lens provides more fill light outside the desired primary beam. Other texturing/diffusion patterns are possible either on the lens 110 or on a separate diffusive film 124 (shown in FIG. 5). Various diffuser film strengths may be used. For example, in the 25 degree beam angle embodiment a diffuser film having a 10 degree full width half maximum (FWHM) strength is suitable.

FIG. 7 shows an exemplary ray-trace for light initially emitted into each of the four regions. The three central rays from region I travel through the axial hole of the intermediate reflector 104. The ray marked II experiences two bounces, the first off the intermediate reflector 104, the second off the outer reflector 106. The ray associated with region III is emitted at a high angle without interacting with either of the reflectors 104, 106. However, this region III ray may encounter a diffusive structure (shown in FIG. 6) at or before the lens 110, redirecting the ray at another angle. The ray coming from region IV reflects once off the outer reflector 106 before it is emitted.

The intermediate reflector 104 and the outer reflector 106 can be modified to provide many different distributions according to a desired center beam candlepower (CBCP) and beam angle. The intermediate reflector 104 should be arranged to ensure that an acceptable portion of the light is emitted within the desired beam angle while minimizing the amount of light that is subject to double-bounce emission and the increased absorption that is associated therewith.

Although the first and second exterior surfaces 602, 604 have linear cross sections, it may be desirable to design them to have non-linear cross sections. For example, the first and second exterior surfaces 602, 604 of the intermediate reflector 104 may be parabolic or ellipsoidal, and the surface of the outer reflector 106 may be compound parabolic. Many other combinations are possible.

It is also possible to vary the output beam profile by adjusting the angles of the first and second exterior surfaces 602, 604.

It is understood that many different beam angles are possible with embodiments of the present invention. FIGS. l-7 illustrate the lamp device 100 which is designed to produce a relatively narrow beam having a 25 degree beam angle.

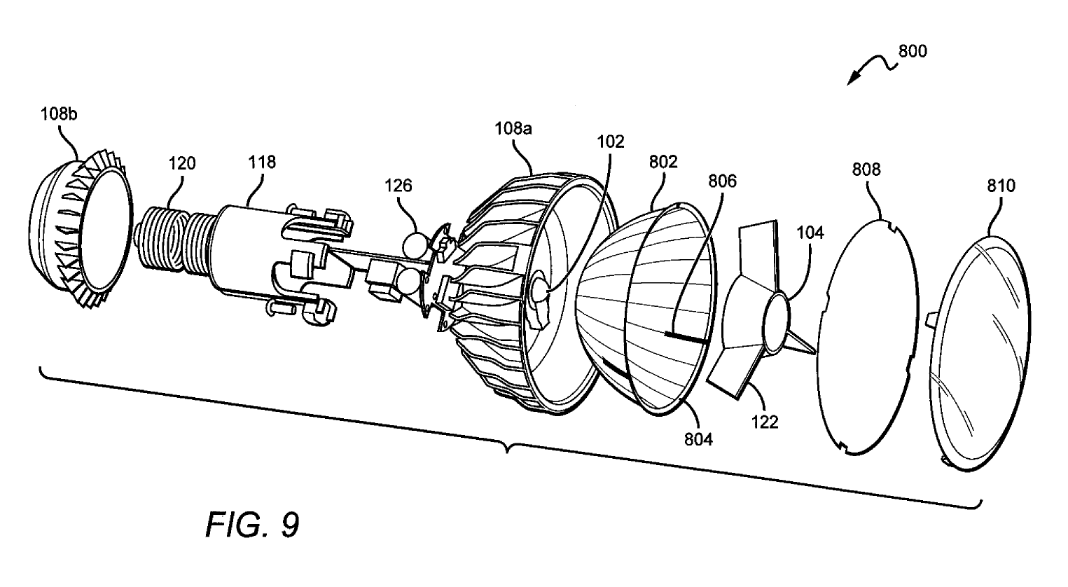

FIGS. 8 and 9 show another embodiment of a lamp device 800 according to the present invention. The lamp device 800 contains many similar elements as the lamp device 100. Similar elements are indicated with the same reference numbers.

FIG. 8 is a perspective view of the lamp device 800 that is designed to produce an output beam having a 50 degree beam angle. The intermediate reflector 104 may be similarly shaped, as in this embodiment, or it may have a different shape. The outer reflector 802 is shaped differently than the outer reflector 106. The outer reflector 802 has a narrower opening at the open end of the housing 108. A flange 804 allows the outer reflector 802 to fit snugly within the housing. The shape of the outer reflector 802 is such that the light is emitted at a wider angle (i.e., 50 degrees). In this embodiment, the outer reflector 802 has a compound parabolic cross-section and comprises adjacent faceted panels similar to the device 100. The device 800 comprises 24 panels; however, because the surface area of the outer reflector 802 is smaller than that of the outer reflector 106, fewer panels may be required. However, this is not necessarily the case especially if the size of the individual panels is decreased.

FIG. 9 is an exploded view of the lamp device 800. Slits 806 allow the intermediate reflector 104 to be mounted to the housing 108 through the outer reflector 802. The flange 804 can either rest on or fit just inside the housing as shown. A stronger diffuser film 808 is used to produce the 50 degree beam angle in this embodiment. For example, a 20 degree FWHM diffuser strength is suitable, although other diffuser strengths may be used. Because the desired 50 degree beam angle is wider in lamp device 800, a stronger diffuser film can be used than can be used in embodiments designed to produce narrower beam angles, such as lamp device 100, for example.

As shown herein, different combinations of the various internal elements can produce an output beam having a wide range of characteristics. Thus, it is possible to achieve different light beams by switching out only a few components. For example, it may be possible to switch from a flood profile to a narrow flood profile or a spot profile by simply replacing the outer reflector and the diffuser film.

FIG. 10 is a bottom view of a lamp device 1000 according to another embodiment of the present invention. The device is similar to lamp device 800 and is designed to produce a 50 degree beam angle output. However, lamp device 1000 comprises only a single leg 1002 to mount the intermediate reflector 104. The leg 1002 extends through the slit 806 in the outer reflector 802, allowing for connection to the housing 108. It may be desirable to use a single thin leg 1002 for mounting so as to minimize the amount of light that is obstructed and possibly absorbed by the mount mechanism. In other embodiments, a pole or a spoke may be used as the mount mechanism.

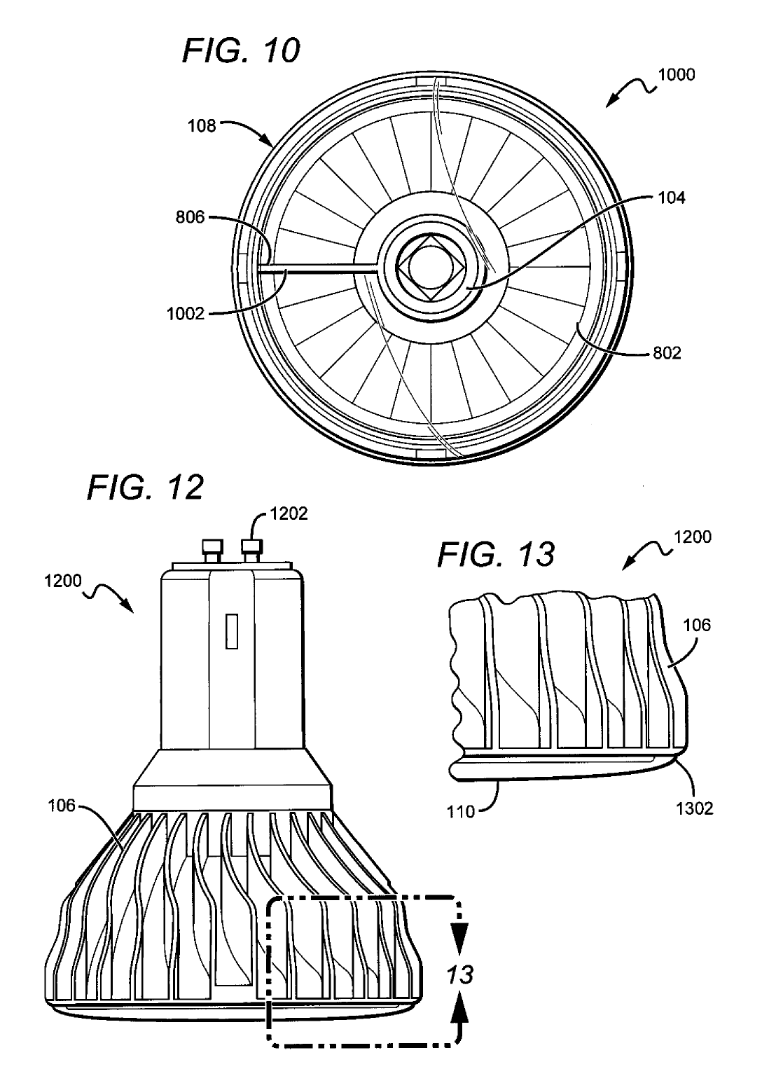

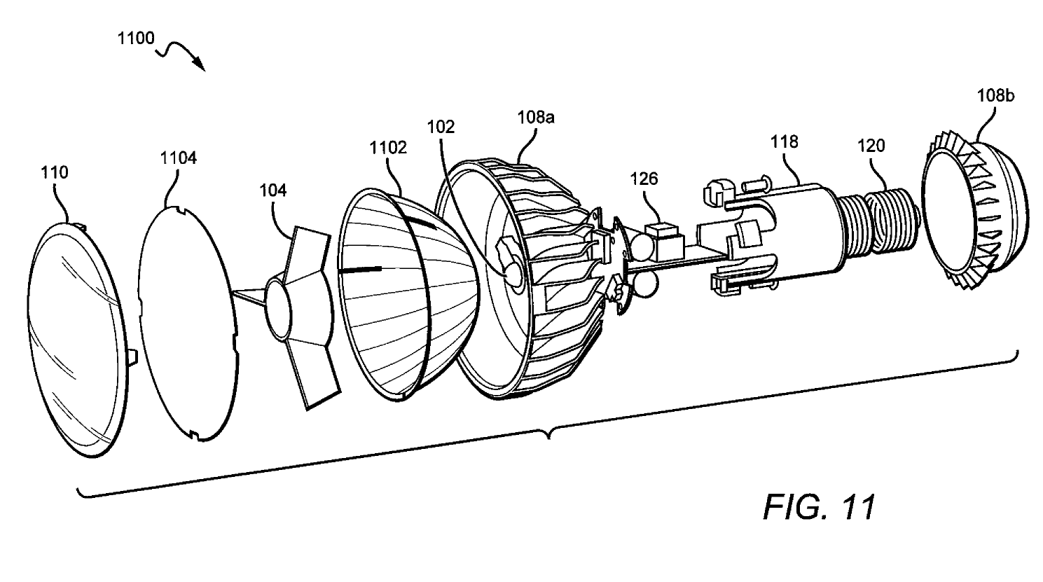

FIG. 11 is an exploded view of a lamp device 1100 according to another embodiment of the present invention. The lamp device 1100 is designed to produce an output beam having a 10 degree beam angle. The intermediate reflector 104 may be similarly shaped, as in this embodiment, or it may have a different shape. The outer reflector 1102 is shaped differently than the outer reflectors 106, 802.

The shape of the outer reflector 1102 is such that the output beam has a 10 degree beam angle. In this embodiment, the outer reflector 1102 comprises adjacent faceted panels similar to the device 100; however, because the lamp device 1100 requires a tighter beam angle than the lamp devices 100, 800, the outer reflector 1102 comprises more panels. The outer reflector 1102 comprises 36 adjacent panels, whereas lamp devices 100, 800 comprise only 24 panels. Generally, the closer the reflector is to a smooth continuous surface around the circumference (e.g., the more panels it has), the tighter the focus of the output beam will be. Other embodiments may comprise more or fewer panels to achieve a particular output beam. The outer reflector 1102 has a compound parabolic cross-section, although other cross-sections are possible.

Because the output beam from the lamp 1100 is narrower than beams from lamp devices 100, 800, the diffuser film 1104 is weaker than those in the lamp devices 100, 800.

FIG. 12 is a side view of a lamp device 1200 according to another embodiment of the present invention. In this particular embodiment, the lamp device 1200 is fitted with a GU24 type electrical connection 1202. Many other types of connections are also possible.

FIG. 13 is a magnified side view of a corner portion of the outer reflector 106 as shown in FIG. 12. In lamp device this embodiment of the lamp device 1200, the edge 1302 at the top face of the lens 110 remains exposed. This allows some of the light incident on the lens 110 close to the edge 1302 of the outer reflector 106 to leak out as high-angle emission. The high-angle leaked light gives an indication to viewers that the lamp 1200 is powered on, even when viewed at relatively high angles (i.e., off-axis). The exposed edge lens can be used with any of the lamp devices discussed herein and with other embodiments not explicitly discussed.

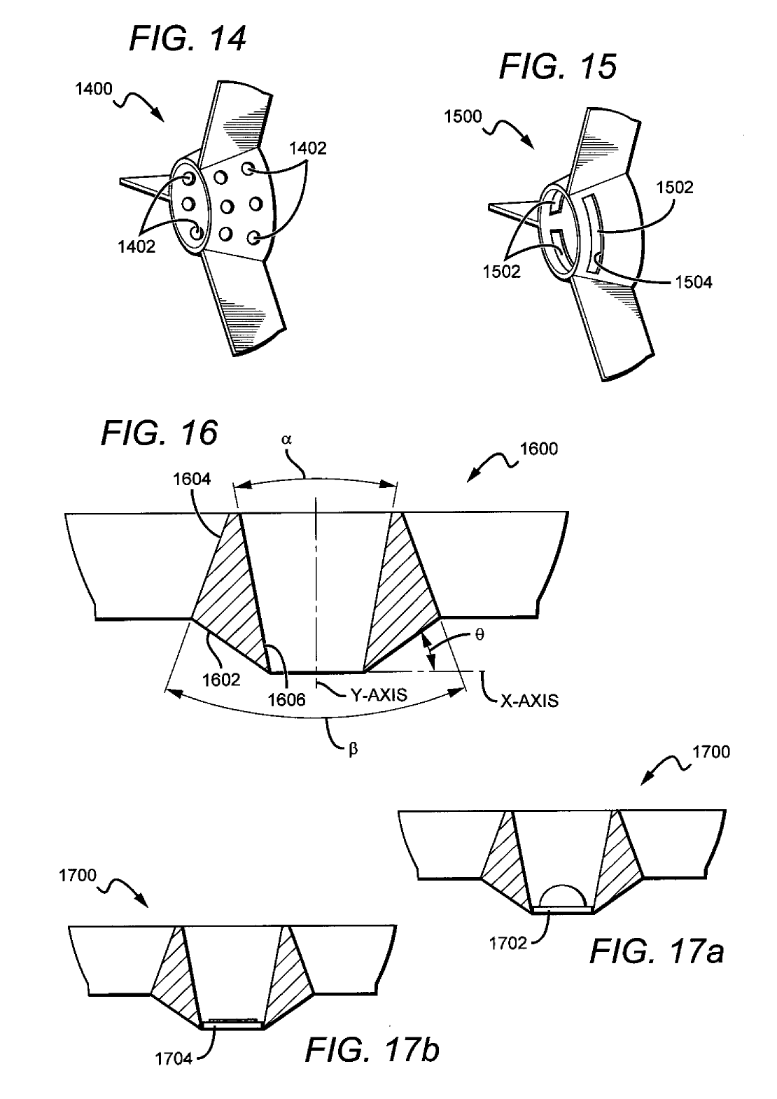

FIG. 14 is a perspective view of an intermediate reflector 1400 according to an embodiment of the present invention. The intermediate reflector 1400 can be used in any of the lamp devices discussed herein and in other embodiments. The intermediate reflector 1400 comprises side holes that allow some of the light emitted into the intermediate reflector 1400 to escape out the sides. The side holes 1402 can be shaped in many different ways and placed in many different configurations to achieve a particular output profile. For example, the side holes 1402 may be circular, elliptical, rectangular, or any other desired shape.

FIG. 15 shows a perspective view of an intermediate reflector 1500 according to an embodiment of the present invention. The side holes 1502 in this embodiment are rectangular slits. Diffusive elements 1504 are disposed in each of the side holes 1502. For example, the diffusive element may be a diffusive film placed within or over the side holes 1502, or it may be a diffusive coating on the inner walls of the side holes 1502. Thus, the light that escapes through the side holes 1502 is scattered by the diffuser to produce a different effect in the output beam profile.

The embodiments shown in FIGS. 14 and 15 are exemplary. Many other different intermediate reflectors that include side holes and/or slits are possible. As discussed, the side holes may contain diffusive elements or other elements such as wavelength conversion materials, for example.

FIG. 16 is a cross-sectional view of an intermediate reflector 1600 according to an embodiment of the present invention. The intermediate reflector 1600 comprises first and second exterior surfaces 1602, 1604 and an interior surface 1606. A horizontal x-axis and a longitudinal y-axis are shown for reference. The interior surface 1606 is oriented at an angle α with respect to the longitudinal y-axis. In this embodiment, a suitable angular range is 10°≦α≦30° with one acceptable value being α=20°. The first exterior surface 1602 is disposed at angle θ from the horizontal x-axis as shown. In this embodiment, a suitable angular range is 20°≦θ≦50° with an acceptable value being θ=34°. The second exterior surface 1604 is oriented at an angle β with respect to the longitudinal y-axis. In this embodiment, a suitable angular range is 20°≦β≦60° with an acceptable value being β=40.3°. The angles α, β, and θ may be adjusted to change the profile of the output light beam. It is understood that the ranges and values given herein are exemplary and that other ranges and values for the angles α, β, and θ may be used in various combinations without departing from the scope of the disclosure.

FIGS. 17a and 17b show cross-sectional views of an intermediate reflector 1700 according to an embodiment of the present invention. The intermediate reflector 1700 comprises an optical element at the end of the longitudinal hole closest to the light source (not shown). In one embodiment, the optical element comprises a collimating lens 1702 as shown in FIG. 17a. The collimating lens 1702 provides added control for light emitted from the source that will be directly emitted through the longitudinal hole. In another embodiment shown in FIG. 17b, an element such as Fresnel lens 1704 may be used to achieve a more collimated central beam portion. Other optical elements may also be used.

Although the present invention has been described in detail with reference to certain configurations thereof, other versions are possible. For example, embodiments of a lamp device may include various combinations of primary and secondary reflectors discussed herein. Therefore, the spirit and scope of the invention should not be limited to the versions described above.

I claim:

1. A reflector system, comprising:
an outer reflector having a bowl shape with a base end and an open end; and
an intermediate reflector disposed inside said outer reflector, said intermediate reflector shaped to define an axial hole.

2. The reflector system of claim 1, said intermediate reflector comprising a reflective interior surface shaped such that said axial hole has a frusto-conical shape.

3. The reflector system of claim 1, said intermediate reflector comprising at least first and second exterior surfaces, said first exterior surface angled to face said base end, said second exterior surface angled to face said open end.

4. The reflector system of claim 1, said intermediate reflector disposed along a longitudinal axis running from the center of said base end to the center of said open end such that said axis runs through the center of said axial hole.

5. The reflector system of claim 1, said intermediate reflector held in place with at least one leg extending from said intermediate reflector to said outer reflector.

6. The reflector system of claim 1, said intermediate reflector held in place with three legs, each of said legs extending from said intermediate reflector to said outer reflector, said legs spaced equidistantly around the exterior of said intermediate reflector.

7. The reflector system of claim 1, further comprising a lens covering said open end of said outer reflector.

8. The reflector system of claim 7, said intermediate reflector attached to said lens.

9. The reflector system of claim 7, said intermediate reflector attachable to said lens with a snap-fit mechanism.

10. The reflector system of claim 7, wherein at least a portion of said lens is roughened.

11. The reflector system of claim 7, wherein an annular section of said lens is roughened, said annular section having an inner and an outer radius, said inner radius located a distance from the center of said lens.

12. The reflector system of claim 7, further comprising a diffusive film disposed on said lens.

13. The reflector system of claim 7, further comprising a diffusive film disposed on an annular section of said lens, said annular section having an inner and an outer radius, said inner radius located a distance from the center of said lens.

14. The reflector of claim 7, wherein at least a portion of an edge of said lens is exposed beyond said outer reflector to allow some of the light incident proximate to said edge to emit at high angles.

15. The reflector of claim 1, further comprising a housing shaped to surround said outer reflector without obstructing said open end.

16. The reflector of claim 15, wherein said housing comprises a thermally conductive material, said housing in thermal contact with said outer reflector.

17. The reflector of claim 1, said outer reflector comprising a faceted surface.

18. The reflector of claim 1, further comprising a collimating optical element disposed within said intermediate reflector at one end of said axial hole.

19. A lamp device, comprising:
a light source;
an outer reflector comprising a base end and an open end, said light source mounted at said base end and arranged to emit light toward said open end;
an intermediate reflector disposed proximate to said light source, said intermediate reflector shaped to define a hole for at least some light from said light source to pass through;
a housing arranged to surround said outer reflector without obstructing said open end; and
a lens arranged to cover said open end.

20. The lamp device of claim 19, said intermediate reflector comprising a reflective interior surface shaped such that said axial hole has a frusto-conical shape.

21. The lamp device of claim 19, said intermediate reflector comprising at least first and second exterior surfaces, said first exterior surface angled to face said base end, said second exterior surface angled to face said open end.

22. The lamp device of claim 19, said intermediate reflector and said light source disposed along a longitudinal axis running from the center of said base end to the center of said open end such that said axis runs through the center of said hole.

23. The lamp device of claim 19, said intermediate reflector held in place with at least one leg extending from said intermediate reflector to said outer reflector.

24. The lamp device of claim 19, said intermediate reflector held in place with three legs, each of said legs extending from said intermediate reflector to said outer reflector, said legs spaced equidistantly around the exterior of said intermediate reflector.

25. The lamp device of claim 19, said intermediate reflector attached to said lens.

26. The lamp device of claim 19, said intermediate reflector attachable to said lens with a snap-fit mechanism.

27. The lamp device of claim 19, wherein at least a portion of said lens is roughened.

28. The lamp device of claim 19, wherein an annular section of said lens is roughened, said annular section having an inner and an outer radius, said inner radius located a distance from the center of said lens.

29. The lamp device of claim 19, further comprising an encapsulant over said light source.

30. The lamp device of claim 29, said encapsulant comprising a diffusive material.

31. The lamp device of claim 19, said light source comprising multiple light emitting diodes (LEDs).

32. The lamp device of claim 19, said light source comprising blue and red LEDs and an encapsulant covering at least some of said LEDs and having a wavelength conversion material disposed to convert at least a portion of blue light from said blue LEDs to yellow light.

33. The lamp device of claim 19, said housing comprising a thermally conductive material, said housing in thermal contact with said light source.

34. The lamp device of claim 19, said outer reflector comprising a faceted interior surface.

35. The lamp device of claim 19, wherein said lamp device produces a light beam having a beam angle of approximately 25 degrees.

36. The lamp device of claim 19, wherein said lamp device produces a light beam having a beam angle of approximately 50 degrees.

37. The lamp device of claim 19, wherein said lamp device produces a light beam having a beam angle of approximately 10 degrees.

38. The lamp device of claim 19, further comprising a diffusive film disposed on said lens.

39. The lamp device of claim 38, further comprising an encapsulant over said light source, said encapsulant comprising a diffusive material.

40. The lamp device of claim 38, wherein said diffusive film is disposed on a surface of said lens that faces said light source.

41. The lamp device of claim 38, wherein said lamp device produces a light beam having a beam angle that is associated with the strength of said diffusive film, such that said beam angle is adjustable by replacing said diffusive film with a different diffusive film.

42. The lamp device of claim 19, further comprising a diffusive film disposed on an annular section of said lens, said annular section having an inner and an outer radius, said inner radius located a distance from the center of said lens.

43. The lamp device of claim 19, wherein said light source comprises at least one light emitting diode (LED).

44. The lamp device of claim 19, wherein at least a portion of an edge of said lens is exposed beyond said housing to allow some of the light incident proximate to said edge to emit at high angles.

45. The lamp device of claim 19, further comprising a collimating optical element disposed within said axial hole at the end of said intermediate reflector closest to said light source.

46. A lamp device, comprising:
an outer reflector comprising a plurality of panels, each of said panels having a cross-section defined by a compound parabola, said panels arranged around a longitudinal axis to define a cavity and an open end; and
an intermediate reflector disposed in said cavity and along said longitudinal axis, said intermediate reflector shaped to define an axial hole along said longitudinal axis.

47. The lamp device of claim 46, said intermediate reflector comprising a reflective interior surface shaped such that said axial hole has a frusto-conical shape.

48. The lamp device of claim 46, said intermediate reflector held in place with at least one leg extending from said intermediate reflector to said outer reflector.

49. The lamp device of claim 46, said intermediate reflector held in place with three legs, each of said legs extending from said intermediate reflector to said outer reflector, said legs spaced equidistantly around the exterior of said intermediate reflector.

50. The lamp device of claim 46, further comprising a lens covering said open end of said outer reflector.

51. The lamp device of claim 50, said intermediate reflector attached to said lens.

52. The lamp device of claim 50, said intermediate reflector attachable to said lens with a snap-fit mechanism.

53. The lamp device of claim 50, wherein at least a portion of said lens is roughened.

54. The lamp device of claim 50, wherein an annular section of said lens is roughened, said annular section having an inner and an outer radius, said inner radius located a distance from the center of said lens.

55. The lamp device of claim 50, wherein a surface of said lens facing away from said intermediate reflector is roughened.

56. The lamp device of claim 50, further comprising a diffusive film disposed on said lens.

57. The lamp device of claim 50, further comprising a diffusive film disposed on an annular section of said lens, said annular section having an inner and an outer radius, said inner radius located a distance from the center of said lens.

58. The lamp device of claim 46, further comprising a housing shaped to surround said outer reflector without obstructing said open end.

59. The lamp device of claim 58, wherein said housing comprises a thermally conductive material, said housing in thermal contact with said outer reflector.

60. The lamp device of claim 58, wherein at least a portion an edge of said lens is exposed beyond said housing to allow some of the light incident proximate to said edge to emit at high angles.

61. The lamp device of claim 46, said intermediate reflector comprising at least first and second exterior surfaces, said first exterior surface angled to face said away from said open end, said second exterior surface angled to face toward said open end.

62. The lamp device of claim 46, said intermediate reflector disposed along said longitudinal axis such that said axis runs through the center of said intermediate reflector.

63. The lamp device of claim 46, further comprising a collimating optical element disposed within said axial hole of said intermediate reflector.
